(19) United States
(12) Patent Application Publication
(10) Pub. No.: US 2026/0313455 A1
(43) Pub. Date: Oct. 8, 2026

(54) FIRST NETWORK NODE, ANOTHER NETWORK NODE AND METHODS PERFORMED THEREBY, FOR HANDLING COMPRESSION OF TRAFFIC

(71) Applicant: Telefonaktiebolaget LM Ericsson (publ), Stockholm (SE)

(72) Inventors: Athanasios KARAPANTELAKIS, SOLNA (SE); Andres REIAL, HOLLVIKEN (SE); Hossein SHOKRI GHADIKOLAEI, TABY (SE); Oleg GORBATOV, Lulea (SE); Caroline SVAHN, Stockholm (SE); Konstantinos VANDIKAS, SOLNA (SE); Lackis ELEFTHERIADIS, VALBO (SE); Abdulrahman ALABBASI, KISTA (SE)

(21) Appl. No.: 19/479,448

(22) PCT Filed: Apr. 27, 2024
(86) PCT No.: PCT/SE2024/050409

§ 371 Date: Oct. 28, 2025

(30) Foreign Application Priority Data
Apr. 28, 2023 (GR) 20230100357

(51) Int. Cl. H04W 28/06; H04W 24/08

(52) U.S. Cl. CPC H04W 28/06; H04W 24/08

(57) ABSTRACT

A method for handling compression of traffic. A first network node (101) obtains (201) respective first information from one or more radio network nodes (110). The radio network nodes (110) have access to a core network (120) via a respective link (140) to a second network node (102). The respective first information indicates: i) one or more respective indications of a status of the radio network nodes (110), and ii) one or more respective characteristics of a respective traffic between the radio network nodes (110) and the second network node (102). The first network node (101) then determines (203), based on the respective first information, a respective type of compression and/or decompression to be applied to the traffic in the respective link (141) between at least a first radio network node (111) and the second network node (102). The first network node (101) then initiates (204) application of the compression and/or decompression of the determined type. Publ.

### TECHNICAL FIELD

The present disclosure relates generally to a first network node and methods performed thereby for handling compression of traffic. The present disclosure further relates generally to another node and methods performed thereby, for handling the compression of traffic. The present disclosure also relates generally to computer programs and computer-readable storage mediums, having stored thereon the computer programs to carry out these methods.

### BACKGROUND

A communications network or communications system may comprise one or more network nodes. A network node may comprise one or more processors which, together with computer program code may perform different functions and actions, a memory, a receiving port, and a sending port. Network nodes may perform their functions entirely on the cloud.

The communications network may cover a geographical area which may be divided into cell areas, each cell area being served by a type of network node, a radio network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), access points, etc., depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The communications network may also comprise network nodes which may serve receiving nodes, such as user equipments, with serving beams.

Wireless devices within a communications network may be e.g., User Equipments (UE), stations (STAs), mobile terminals, wireless terminals, terminals, and/or Mobile Stations (MS). Wireless devices are enabled to communicate wirelessly in a communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

In the course of operations of the communications network, data may be collected on the performance of the telecommunications network, which may enable to monitor and manage the malfunctioning of any of its elements.

The advent of for example, the Internet of Things (IoT) has exponentially increased the amount of data to be monitored. The availability of large amounts of data, such as those collected for example, from IoT devices, may be understood to enable the possibility of analysing such data to make predictions on events, with a high predictive power. To make predictions on events may be understood to refer to building mathematical models that may fit those data, which mathematical models may then be used to make predictions for such events. Within this context, machine learning models may be used to analyze the data collected and enable an improved management of the operation of the telecommunications network.

### Machine Learning

Machine learning (ML) may be understood as the study of computer algorithms that may improve automatically through experience. It is seen as a part of Artificial Intelligence (AI). ML algorithms may build a model based on sample data, known as “training data”, in order to make predictions or decisions without being explicitly programmed to do so. ML algorithms may be used in a wide variety of applications, such as email filtering and computer vision, where it may be difficult or unfeasible to develop conventional algorithms to perform the needed tasks.

There may be basically 3 types of ML Algorithms: Supervised Learning, Unsupervised Learning, and Reinforcement Learning (RL).

Supervised Learning algorithms may comprise a target/outcome variable, or dependent variable, which may have to be predicted from a given set of predictors, that is, independent variables. Using this set of variables, a function may be generated that may map inputs to desired outputs. The training process may continue until the model may achieve a desired level of accuracy on the training data. Once an ML model may have been trained, an inference process may begin, whereby new data may be run through the ML model to calculate an output. Examples of Supervised Learning may be Regression, Decision Tree, Random Forest, KNN, Logistic Regression etc.

In Unsupervised Learning algorithms, there may be no target or outcome variable to predict/estimate. It may be used for clustering a population into different groups, which may be widely used for segmenting customers in different groups for specific intervention. Examples of Unsupervised Learning may be K-means, mean-shift clustering, Density-Based Spatial Clustering of Applications with Noise (DBSCAN), Expectation-Maximization (EM) Clustering using Gaussian Mixture Models (GMM), Agglomerative Hierarchical Clustering, etc.

Cluster analysis or clustering may be understood as an ML technique which may comprise grouping a set of objects in such a way that objects in the same group, which may be called a cluster, may be understood to be more similar, in some sense, to each other than to those in other groups, that is, other clusters. It may be understood as a main task of exploratory data mining, and a common technique for statistical data analysis, used in many fields, including pattern recognition, image analysis, information retrieval, bioinformatics, data compression, computer graphics and ML.

Using an RL algorithm, a machine may be trained to make specific decisions. It may be understood to work as follows: the machine may be exposed to an environment where it may train itself continually using trial and error. This machine may learn from past experience and may try to capture the best possible knowledge to make accurate business decisions. An example of RL may be a Markov Decision Process (MDP). The training using RL may comprise generating an ML model. To train such an ML model, an agent, given a state of the environment, may take an action in this environment and receive a reward. The action may result in a new state of the environment. This process may be repeated in a loop. Over time, the agent may learn to take actions that may result in larger immediate and future rewards, meaning that it may be understood to be in the best interest of the agent not to take the action that may only lead to the highest reward in the next state, but the action that may cumulatively lead to the highest reward in the next state and in a future number of states.

The agent may comprise a neural network which may input the state and may produce an action. There may be several ML algorithms that may be used for training the network of the agent, e.g., policy-learning based, such as actor-critic approaches or value-based learning such as deep-q networks.

### NR

The standardization organization 3rd Generation Partnership Project (3GPP) is currently in the process of specifying a New Radio Interface called New Radio (NR) or 5G-Universal Terrestrial Radio Access (UTRA), as well as a Fifth Generation (5G) Packet Core Network, which may be referred to as Next Generation (NG) Core Network, abbreviated as NG-CN, NGC or 5G CN.

In the current concept, gNB denotes an NR BS, where one NR BS may correspond to one or more transmission and/or reception points.

One of the main goals of NR is to provide more capacity for operators to serve ever increasing traffic demands and variety of applications. Because of this, NR may be able to operate on high frequencies, such as frequencies over 6 GHz, until 60 or even 100 GHz.

Operation in higher frequencies makes it possible to use smaller antenna elements, which enables antenna arrays with many antenna elements. Such antenna arrays facilitate beamforming, where multiple antenna elements may be used to form narrow beams and thereby compensate for the challenging propagation properties.

### MIMO

Multiple Input Multiple Output (MIMO) may be understood as a technology that may increase the capacity and coverage of a radio link using arrays of reception and transmission (Rx/Tx) antennas, also known as Transmission and Reception Points (TRPs).

### Distributed MIMO (D-MIMO)

Distributed MIMO (D-MIMO) may use a set of physical/logical antenna arrays, which may be spatially distributed. A D-MIMO network may comprise L geographically distributed TRPs, each equipped with N antenna elements. The total number of antennas in the network may be N×L. The TRPs may be connected via links to Central Processing Units (CPUs), which may facilitate the coordination among TRPs. In D-MIMO, the point-to-point network interface between the TRPs and the reception point at the macro cell at the radio base station may be known as fronthaul (FH). The TRPs may be cooperating to serve K User Equipments (UEs) in the coverage area jointly, by coherent transmission in the downlink and reception in the uplink.

D-MIMO may be understood to have some advantages over co-located MIMO, such as flexibility to address interference, robustness to loss of Line of Sight (LoS), better diversity, and further enhancing capacity by taking advantage of multiple physical antennas.

The data traffic that may be sent to and from the UEs that may be attached to the TRPs may be understood to go through the FH. Therefore, compressing data traffic on the FH interface, thereby saving bandwidth, may be understood to be a relevant challenge. In cloud RAN (C-RAN) and open RAN (ORAN), point-to-point FH compression has been researched on the interface between the control unit (CU) and the radio units (RUs) [1]. In such environments, the connection between the endpoints may be envisioned to use high-capacity optical fiber or ethernet cables. The same may be true for some current products. Also, both CU and RU in O/C-RAN may be understood to be meant to be virtual functions residing in datacenters with ample compute capacity, which may be understood to also mean that it may be possible to run sophisticated compression algorithms.

Existing methods for FH compression provide several approaches.

In [2], the authors focus on the uplink of cell-free MIMO under limited capacity FH links and transceiver hardware impairments. The authors have investigated three transmission strategies at access points, which may be BSs in a cloud RAN setup, to compress and forward data to a Central Processing Unit (CPU), hosted at the edge cloud. The authors considered various implementation scenarios, including channel estimation at the Access Points (APs) or 5 CPU, and MIMO detection at the Base Stations (BSs) or CPU.

In [3], the authors focus on cell-free MIMO with limited-capacity FH links and low-resolution digital-to-analog converters, leading to a) compression of the data transmitted via the FH and b) compression noise. The authors consider those two effects and propose a method based on zero-forcing precoding to achieve fairness in the allocated rates to UEs. Motivated by the fact that latency-sensitive traffic requires high bandwidth in FH, in [4], the authors use an algorithm to minimize latency using an Analog-to-Digital-Compression Radio-Over-Fiber (ADX-RoF) approach. This approach is fundamentally different than wireless communication, as in RoF, light may be understood to be amplitude modulated by a radio signal and transmitted over an optical fiber link.

In [5], the authors propose an adaptive spatial filter-based approach to the signal subspace which may reduce the number of spatial channels followed by adaptive quantization of each channel in the time domain. The proposed approach is based on principal component analysis (PCA), which as the name suggests, identifies the principal components, or features, of the channel which may be of importance based on the eigenvalues and corresponding eigenvectors of the covariance matrix for every feature.

In [6], the main idea is to propose a joint decompression and demodulation (JDD) algorithm at the baseband unit (BBU). This algorithm takes into consideration both the fading and compression effect in a single decoding step. The algorithm is analyzed in closed form by using pairwise error probability analysis and based on this analysis, adaptive compression schemes are proposed with the consideration of quality of service (QoS) constraints to minimize the FH transmission rate while satisfying the pre-defined target QoS.

In spite of the varied approaches to perform compression within the context of a communications network, existing compression methods may still result in poor traffic management in a communications network.

### SUMMARY

As part of the development of embodiments herein, one or more problems with the existing technology will first be identified and discussed.

Transmission and Reception Point (TRP) endpoints in D-MIMO may be understood to be meant to be low-cost data relays with limited computational capability. Existing methods for handling compression of traffic, however, provide no consideration of computational capability and availability for compression/decompression activities, as well as the power consumption of endpoints as part of the goal. Existing methods may be understood to mostly focus on reducing data transmission through compression and/or rate adaptation, by adjusting some parameters.

In addition, the FH in D-MIMO may be typically wireless, which incurs additional constraints for compression methods that may potentially be used. Selecting a proper method of compression for D-MIMO may be understood to be highly circumstantial, depending on the conditions of the wireless channel and the capacity/capability of the TRP. Compression methods that may be optimal for fiber links may not be suitable to wireless links.

Existing methods further lack an optimization of multiple FH links at the same time, as opposed to an optimization of a single link. This may be understood to mean, for example, one of the FH links. Existing approaches may not be trivially extended to cover this aspect.

Furthermore, existing methods lack a consideration towards individual user traffic requirements, but instead take a maximalist approach, considering overall, e.g., sum rate, and other Key Performance Indicator (KPI) traffic requirements.

It is therefore an object of embodiments herein to improve the handling of compression of traffic in a communications network.

According to a first aspect of embodiments herein, the object is achieved by a computer-implemented method, performed by a first network node. The method is for handling compression of traffic. The first network node operates in a communications network. The first network node obtains respective first information from one or more radio network nodes. The one or more radio network nodes have access to a core network of the communications network via a respective link to a second network node operating in the communications network. The respective first information indicates one or more respective indications of a status of the one or more radio network nodes. The respective first information also indicates one or more respective characteristics of a respective traffic between the one or more radio network nodes and the second network node. The first network node then determines, based on the obtained respective first information, a respective type of compression and/or decompression to be applied to the respective traffic in the respective link between at least a first radio network node of the one or more radio network nodes and the second network node. The first network node then initiates application of the compression and/or decompression of the determined respective type to the respective traffic in the respective link.

According to a second aspect of embodiments herein, the object is achieved by a computer-implemented method, performed by another network node. The method is for handling the compression of traffic. The another network node operates in the communications network. The another network node obtains a respective first indication from the first network node operating in the communications network. The respective first indication indicates the respective type of compression and/or decompression to be applied to the respective traffic in the respective link between the respective radio network node of the one or more radio network nodes and the second network node operating in the communications network. The one or more radio network nodes have access to the core network of the communications network via the respective link to the second network node. The respective type of compression is based on the respective first information. The respective first information indicates the one or more respective indications of the status of the one or more radio network nodes. The respective first information also indicates the one or more respective characteristics of the respective traffic between the one or more radio network nodes and the second network node. The another network node then initiates application of the compression and/or decompression of the indicated respective type to the respective traffic in the respective link.

According to a third aspect of embodiments herein, the object is achieved by the first network node. The first network node may be understood to be for handling the compression of traffic. The first network node is configured to operate in the communications network. The first network node is further configured to obtain the respective first information from the one or more radio network nodes. The one or more radio network nodes are configured to have access to the core network of the communications network via the respective link to the second network node configured to operate in the communications network. The respective first information is configured to indicate the one or more respective indications of the status of the one or more radio network nodes. The respective first information is also configured to indicate the one or more respective characteristics of the respective traffic between the one or more radio network nodes and the second network node. The first network node is further configured to determine, based on the respective first information configured to be obtained, the respective type of compression and/or decompression to be applied to the respective traffic in the respective link between at least the first radio network node of the one or more radio network nodes and the second network node. The first network node is additionally configured to initiate application of the compression and/or decompression of the respective type configured to be determined, to the respective traffic in the respective link.

According to a fourth aspect of embodiments herein, the object is achieved by the another network node. The another network node may be understood to be for handling the compression of traffic. The another network node is configured to operate in the communications network. The another network node is configured to obtain the respective first indication from the first network node configured to operate in the communications network. The respective first indication is configured to indicate the respective type of compression and/or decompression to be applied to the respective traffic in the respective link between the respective radio network node of one or more radio network nodes and the second network node configured to operate in the communications network. The one or more radio network nodes are further configured to have access to the core network of the communications network via the respective link to the second network node. The respective type of compression is configured to be based on the respective first information. The respective first information is configured to indicate the one or more respective indications of the status of the one or more radio network nodes. The respective first information is also configured to indicate the one or more respective characteristics of the respective traffic between the one or more radio network nodes and the second network node. The another network node is further configured to initiate application of the compression and/or decompression of the determined respective type to the respective traffic in the respective link.

According to a fifth aspect of embodiments herein, the object is achieved by a computer program, comprising instructions which, when executed on at least one processing circuitry, cause the at least one processing circuitry to carry out the method performed by the first network node.

According to a sixth aspect of embodiments herein, the object is achieved by a computer-readable storage medium, having stored thereon the computer program, comprising instructions which, when executed on at least one processing circuitry, cause the at least one processing circuitry to carry out the method performed by the first network node.

According to a seventh aspect of embodiments herein, the object is achieved by a computer program, comprising instructions which, when executed on at least one processing circuitry, cause the at least one processing circuitry to carry out the method performed by the another network node.

According to an eighth aspect of embodiments herein, the object is achieved by a computer-readable storage medium, having stored thereon the computer program, comprising instructions which, when executed on at least one processing circuitry, cause the at least one processing circuitry to carry out the method performed by the another network node.

Various compression methods may correspond to different compression ratios and type of compression, e.g., lossless or lossy- and in case of the latter percentage of loss, and therefore, to different capacity requirements or availability on the respective link, e.g., the FH link, and different permissible noise or distortion levels on the data to be transmitted on the respective link, e.g., the FH data, being lossless or lossy. By obtaining the respective first information from the one or more radio network nodes, the first network node may be enabled to determine what type of compression and/or decompression method to deploy, if needed and supported at what respective link, based on the collected respective first information.

By determining the respective type of compression and/or decompression to be applied to the respective traffic in the respective link between at least the first radio network node, of the one or more radio network nodes, and the second network node, the first network node may be enabled to perform a joint optimization of the compression and/or decompression selection and optionally, rate allocation, for every respective link, e.g., TRP FH link. When different radio network nodes of the one or more radio network nodes, e.g., TRPs, may require different throughput on the backhaul link, e.g., due to serving a different number of users or due to serving users with different service types, the first network node may then be enabled to select the proper compression and/or decompression algorithm for the respective link between the respective radio network node, e.g., TRP, and the second network node, e.g., the macro node, by relying on the respective first information collected from all the one or more radio network nodes. Embodiments herein may therefore enable to jointly optimize the compression and/or decompression selection for every respective link, e.g, TRP FH link, by performing the determination using the respective first information collected from all the one or more radio network nodes. Furthermore, the first network node may be enabled to perform the selection of compression/decompression taking into consideration individual user traffic requirements, as well as computational capability and availability for compression/decompression activities, as well as the power consumption of endpoints.

By obtaining the respective first indication from the first network node indicating the respective type of compression and/or decompression to be applied to a respective traffic in the respective link, the another network node may be enabled to initiate applying the compression and/or decompression of the indicated respective type to the respective traffic in the respective link, thereby implementing the optimized compression and/decompression selection and thereby enabling to optimally save bandwidth with the advantages described for the selection of compression and/decompression type for the first network node, e.g., taking into consideration individual user traffic requirements, as well as computational capability and availability for compression/decompression activities, as well as the power consumption of endpoints.

Hence, transmission of information in the communications network may be optimized, as a compression type may be chosen and then applied, that may decrease the volume of data that may need to be transmitted, without delaying the transmission or using more compute than may be available, or creating unnecessary overhead on the receiver that may need to decompress the data.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications network, according to embodiments herein.

FIG. 2 is a flowchart depicting a method in a first network node, according to embodiments herein.

FIG. 3 is a flowchart depicting a method in another network node, according to embodiments herein.

FIG. 4 is a schematic diagram depicting particular aspects of a non-limiting example of the method performed by the first network node and the another network node, according to embodiments herein.

FIG. 5 is a schematic block diagram illustrating an embodiment of a first network node, according to embodiments herein.

FIG. 6 is a schematic block diagram illustrating an embodiment of another network node, according to embodiments herein.

### DETAILED DESCRIPTION

Certain aspects of the present disclosure and their embodiments address the challenges identified in the Background and Summary sections with the existing methods and provide solutions to the challenges discussed.

Embodiments herein may be understood to relate to FH compression for D-MIMO. Particular embodiments herein may be understood to provide a system and method for automatic selection and deployment of the compression method based on the current condition of the FH.

Various compression methods may correspond to different compression ratios, and therefore to different capacity requirements or availability on the FH link, and different permissible noise or distortion levels on the FH data, being lossless or lossy. When different TRPs may require different throughput on the backhaul link, e.g., due to serving a different number of users or due to serving users with different service types, embodiments herein may enable to select the proper compression algorithm for the link between TRP and the macro node by collecting relevant data from all TRPs. Embodiments herein may also enable to jointly optimize the compression selection and rate allocation for every TRP FH link, by collecting relevant data from all TRPs.

Specifically, embodiments herein may provide a logical control method, preferably hosted either at the macro cell, or equivalently a node that may functionally correspond to a Distributed Unit (DU) or a Centralized Unit (CU) in the 5G architecture, or at the core network, that may have connectivity to every TRP, or equivalently a node corresponding to a RU, or an AP. A method according to embodiments herein may comprise two phases.

In a first phase, data may be collected, wherein information about the status of every point-to-point front haul link between every TRP and the macro-cell may be collected, in addition to information about the mobility and traffic profile of every UE being served by each TRP.

In a second phase, the selection, based on data collected from the previous phase, deployment and activation of the compression method in both or either of the uplink and downlink interface for every <TRP, macro> pair may be performed.

In some embodiments, joint optimization of the compression selection and rate allocation for every TRP FH link may be enabled. In such embodiments, in the data collection phase, the service/rate requirements of the UEs connected to one TRP may be collected, in addition to the data being collected. The macro node may then allocate the rates to the FH links, that is, adjust the transmission rate in the FH links, e.g., how many bits/see, based on which a compression scheme may be selected for that link. There may be multiple ways to control the rate of various FH links, including power allocation from macro toward various TRPs.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Several embodiments and examples are comprised herein. It should be noted that the embodiments and/or examples herein are not mutually exclusive. Components from one embodiment or example may be tacitly assumed to be present in another embodiment or example and it will be obvious to a person skilled in the art how those components may be used in the other exemplary embodiments and/or examples.

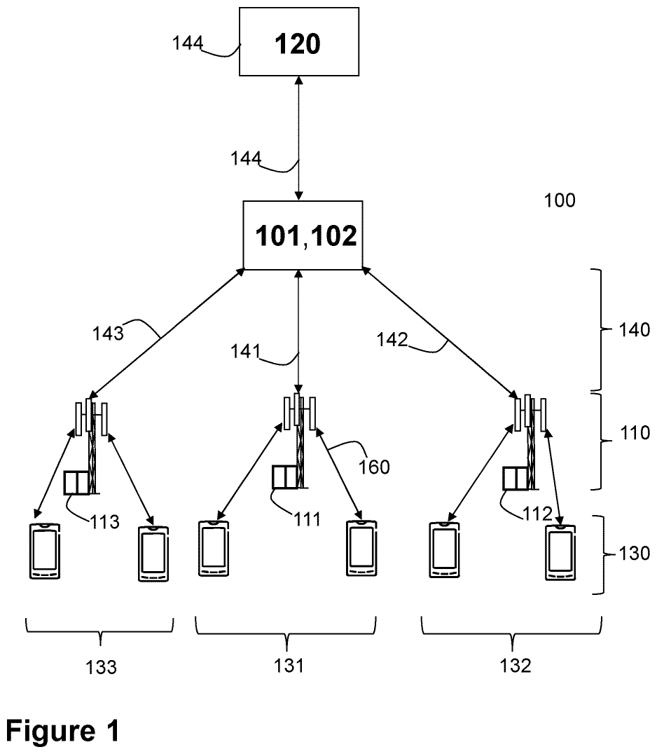

FIG. 1 depicts a non-limiting example of a communications network 100, sometimes also referred to as a communication system, such as a wireless communications network, wireless communications system, cellular radio system, or cellular network, in which embodiments herein may be implemented. The communications network 100 may typically be a 5G system, 5G network, NR-U or Next Gen System or network. The communications network 100 may support a newer system than a 5G system, such as, for example, a 6G system. The communications network 100 may support other technologies, such as, for example Long-Term Evolution (LTE), LTE-Advanced/LTE-Advanced Pro, e.g., LTE Frequency Division Duplex (FDD), LTE Time Division Duplex (TDD), LTE Half-Duplex Frequency Division Duplex (HD-FDD), LTE operating in an unlicensed band, Licensed-Assisted Access (LAA), MulteFire etc. Other examples of other technologies the communications network 100 may support may be Wideband Code Division Multiple Access (WCDMA), Universal Terrestrial Radio Access (UTRA) TDD, Global System for Mobile Communications (GSM) network, Enhanced Data Rates for GSM Evolution (EDGE) network, GSM EDGE Radio Access Network (GERAN) network, Ultra-Mobile Broadband (UMB), network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, Narrowband Internet of Things (NB-IoT), or any cellular network or system. It may be noted that the communications network 100 may comprise a backhaul part, e.g., the fourth link 144 described below, which may be partially implemented as a non-terrestrial network (NTN), e.g., using drones or satellites. Thus, although terminology from 5G/NR and LTE may be used in this disclosure to exemplify embodiments herein, this should not be seen as limiting the scope of the embodiments herein to only the aforementioned systems.

In particular embodiments herein, the communications network 100 may be a D-MIMO network.

The communications network 100 comprises a plurality of network nodes, whereof a first network node 101 and a second network node 102 are depicted in FIG. 1. The communications network 100 also comprises one or more radio network nodes 110. The one or more radio network nodes 110 comprises at least a first network node 111. In the non-limiting example of FIG. 1, and for illustration purposes only, the one or more radio network nodes 110 comprise the first radio network node 111, a second radio network node 112 and a third radio network node 113. It may be understood that this is for illustration purposes only, and that the one or more radio network nodes 110 may comprise further or fewer radio network nodes.

Any of the second network node 102, the one or more radio networks 110, or in particular, the first radio network node 111, may be referred to herein as another network node 102, 110, 111.

The one or more radio network nodes 110 in the communications network 100 may be organized in a distributed arrangement converging towards the second network node 102, which may be understood to be a central network node or managing network node. The arrangement may be understood as a spatial arrangement, wherein the plurality of network nodes may be geographically distributed.

In typical embodiments, the first network node 101 may be the same network node, or may be co-located with, the second network node 102, as depicted in the non-limiting example of FIG. 1. In other embodiments not depicted in FIG. 1, the first network node 101 may be a different network node than the second network node 102, and be co-located or located elsewhere, e.g., in the cloud.

The arrangement may have different shapes, such as serial, parallel or grid. That is, the arrangement may be understood to be flexible, with different topologies. In some non-limiting examples, some of the network nodes, which may be adjacent to each other, may be located forming stripes, e.g., forming a single line of adjacently located network nodes. The arrangement may additionally or alternatively comprise different branches of adjacently located network nodes, wherein the branches may radially end converge at the central network node 110.

Any of the first network node 101, the second network node 102 and the one or more radio network nodes 110, such as the first radio network node 111, the second radio network node 112, the third radio network node 113, and the another network node 102, 110, 111 may be a radio network node, capable of serving a wireless device, for example, a user equipment or a machine type communication device, in the communications network 100.

Any of the first network node 101 and the second network node 102 may be a base station, such as a gNB in 5G or an eNB in 4G. In other examples, any of the first network node 101 and the second network node 102 may be a distributed node, such as a virtual node in the cloud, and may perform its functions entirely on the cloud, or partially, in collaboration with a radio network node.

The second network node 102 may be a Central Processing Unit (CPU). The second network node 102 may be understood as a network node having a capability to coordinate the operation of the one or more radio network nodes 110, e.g., the first radio network node 111, the second radio network node 112 and the third radio network node 113.

Any of the one or more radio network nodes 110 may be a TRP or an access point (AP) and may have a fronthaul connection to the second network node 102. As TRPs, any of the one or more radio network nodes 110 may manage a respective plurality of antenna elements.

The communications network 100 also comprises a core network 120. The core network 120 may comprise one or more core network nodes, such as, for example, an Access and Mobility Management Function (AMF) or a Mobility Management Entity (MME).

The first network node 101, in some examples, may be a core network node.

The second network node 102 may be directly connected to one or more core networks, e.g., a third network node comprised in the core network 120, through one or more backhaul connections.

The communications network 100 may cover a geographical area, which in some embodiments may be divided into cell areas, wherein each cell area may be served by a radio network node, although, one radio network node may serve one or several cells. In the examples of FIG. 1, cells are not represented. Any of the first network node 101, the second network node 102 and the one or more radio network nodes 110, e.g., the first radio network node 111, the second radio network node 112, and the third radio network node 113 may be of different classes, such as, e.g., macro eNodeB, home eNodeB or pico base station, based on transmission power and thereby also cell size. In some examples, any of the first network node 101, the second network node 102 and the one or more radio network nodes 110, e.g., the first radio network node 111, the second radio network node 112, and the third radio network node 113 may serve receiving nodes with serving beams. The radio network node may support one or several communication technologies, and its name may depend on the technology and terminology used.

The one or more radio network nodes 110 may belong to a first group of radio network nodes which may have limited capabilities with respect to a second group of radio network nodes, e.g., full gNBs. For example, the one or more radio network nodes 110, e.g., may be TRPs, which may be comparatively low cost and have limited computational capabilities.

One or more wireless devices 130 may be comprised in the wireless communication network 100. In the non-limiting example of FIG. 1, the one or more wireless devices 130 are represented as comprising six wireless devices. However, this may be understood to be for illustration purposes only. The one or more wireless devices 130 may comprise additional, or fewer, wireless devices. Any of the one or more wireless devices 130 comprised in the communications network 100 may be a wireless communication device such as a 5G UE, or a UE, which may also be known as e.g., mobile terminal, wireless terminal and/or mobile station, a Customer Premises Equipment (CPE) a mobile telephone, cellular telephone, or laptop with wireless capability, just to mention some further examples. Any of the one or more wireless devices 130 comprised in the communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. Any of the one or more wireless devices 130 comprised in the communications network 100 may be enabled to communicate wirelessly in the communications network 100. The communication may be performed via the one or more radio network nodes 110 and possibly the one or more core networks, which may be comprised within the communications network 100.

Each radio network node, of the one or more radio network nodes 110, may serve a respective set 131, 132, 133 of the one or more wireless devices 130. In the non-limiting example depicted in FIG. 1, the first radio network node 111 serves a first set 131 of the one or more wireless devices 130 comprising two wireless devices, the second radio network node 112 serves a second set 132 of the one or more wireless devices 130 comprising two wireless devices, and the third radio network node 113 serves a third set 133 of the one or more wireless devices 130 comprising two wireless devices.

Any of the radio network nodes in the one or more radio network nodes 110 may be configured to communicate with the second network node 102 over a respective link 140. The respective link 140 may be understood to be a fronthaul (FH) link. The respective link 140 may be wireless. In the example illustrated in FIG. 1, the first radio network node 111 may be configured to communicate within the communications network 100 with the second network node 102 over a respective first link 141, that is, their respective link 141, e.g., a radio link. The second radio network node 112 may be configured to communicate within the communications network 100 with the second network node 102 over a respective second link 142, e.g., a radio link. The third radio network node 113 may be configured to communicate within the communications network 100 with the second network node 102 over a respective third link 143, e.g., a radio link. The second network node 102 may be configured to communicate within the communications network 100 with the core network 120 over a fourth link 144, e.g., a wired link. The fourth link 144 may be understood to be a backhaul (BH) link.

Any of the one or more wireless devices 130 may be configured to communicate within the communications network 100 with any of the respective radio network nodes, of the one or more radio network nodes 110, serving them, over a respective radio link 160, e.g., a radio link.

In general, the usage of “first”, “second”, “third” and/or “fourth” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a first network node, such as the first network node 101, e.g., a gNB or a core network node, and embodiments related to a another network node, such as the another network node 102, 110, 111 e.g., the same gNB, a different gNB, or a TRP.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

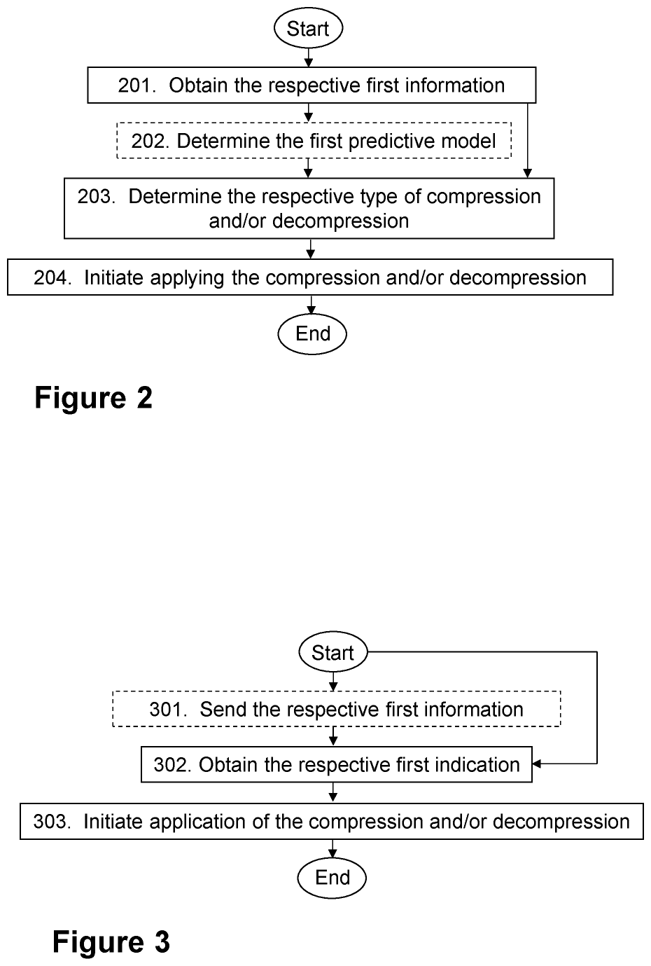

Embodiments of a computer-implemented method, performed by the first network node 101, will now be described with reference to the flowchart depicted in FIG. 2. The method is for handling compression of traffic. The first network node 101 operates in the communications network 100.

In some embodiments, the communications network 100 may be a D-MIMO network.

Several embodiments are comprised herein. In some embodiments all the actions may be performed. In some embodiments, some actions may be optional. In FIG. 2, an optional action is indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description.

### Action 201

In this Action 201, the first network node 101 obtains respective information, referred to herein as respective first information, from the one or more radio network nodes 110. Respective here may be understood to mean that, from every radio network node of the one or more radio network nodes 110, the first network node 101 may collect first information pertaining to that node.

As stated earlier, the one or more radio network nodes 110 have access to the core network 120 of the communications network 100 via the respective link 140 to the second network node 102 operating in the communications network 100. The second network node 102 may then have the backhaul link 144 with the core network 120.

The respective first information indicates i) one or more respective indications of a status, e.g., over a first period of time, of the one or more radio network nodes 110, and ii) one or more respective characteristics of a respective traffic between the one or more radio network nodes 110 and the second network node 102, e.g., over the first period of time.

Obtaining in this Action 201 may comprise receiving, directly or indirectly, from the one or more radio network nodes 110.

In some examples of embodiments herein, the first network node 101, may be managing, or residing at, a macro cell in a D-MIMO deployment, and may collect the respective first information from every radio network node of the one or more radio network nodes 110, e.g., per TRP, and/or for every TRP.

The respective first information may be obtained in the form of a respective report.

In some embodiments, at least one of the following features may apply.

The one or more respective indications of the status of the one or more radio network nodes 110 may be associated to a respective identifier (ID) of the one or more radio network nodes 110. As the respective first information may be understood to be reported per TRP, the respective ID may be a TRP identifier (TRP ID) which may uniquely identify the TRP to the first network node 101. An example of such identifier may be a Media Access Control (MAC) address of the TRP radio interface.

The one or more respective indications of the status of the one or more radio network nodes 110 may comprise at least one of the following.

According to a first option, the one or more respective indications of the status of the one or more radio network nodes 110 may comprise respective one or more indicators of a hardware status of the one or more radio network nodes 110. The respective one or more indicators of the hardware status of the one or more radio network nodes 110 may be referred to as capabilities of the one or more radio network nodes 110. The respective one or more indicators of the hardware status may comprise one or more indicators of: computational, memory and power. The respective one or more computational indicators of the hardware status may comprise CPU load, e.g., percentage of total, compute capacity, e.g., in terms of Floating Operations Per Second (FLOPS). The indicator of compute capacity may be e.g., Compute_capacity. The indicator of CPU utilization may be e.g., CPU_Utilization.

The respective one or more indicators of the hardware memory status may comprise for example memory capacity, e.g., in GigaBytes (GB), and memory utilization, e.g., percentage of total. The indicator of memory capacity may be e.g., Memory_capacity. The indicator of memory utilization may be e.g., Memory_Utilization.

The respective one or more indicators of hardware power status may comprise power characteristics such as power source, e.g., power grid/renewables, current power supply and consumption, e.g., in Watts (W), battery Depth of Discharge (DoD) and/or State of Charge (SoC), e.g., as percentage.

The one or more respective indications of the status of the one or more radio network nodes 110 may also comprise information pertaining to the one or more wireless devices 130. Particularly, according to a second option, the one or more respective indications of the status of the one or more radio network nodes 110 may comprise a respective current camping time of the respective set 131, 132, 133 of the one or more wireless devices 130 served by the respective one or more radio network nodes 110. For example, for the first radio network node 111, this may be the respective current camping time of the first set 131 of the one or more wireless devices 130, which may be understood to be served by the first radio network node 111. The respective current camping time of the respective set 131, 132, 133 of the one or more wireless devices 130 served by the respective one or more radio network nodes 110 may comprise, for example, average, or detailed if available, cell camping time, e.g., aggregate or detailed per wireless device, for example as a list, e.g., list [UEID, Camping_time]. The average camping time may be indicated as e.g., avg_camping_time.

According to a third option, the one or more respective indications of the status of the one or more radio network nodes 110 may comprise a respective load, referred to herein as respective first load, of the one or more radio network nodes 110.

According to a fourth option, the one or more respective indications of the status of the one or more radio network nodes 110 may comprise respective historical mobility propensity of the one or more radio network nodes 110. That is, for example, a typical rate or probability of occurrence of high-mobility UEs at the respective radio network node of the one or more radio network nodes 110. Optionally, the core network 120, for example, an Operation and Maintenance (OAM) node comprised in the core network 120, may be consulted to retrieve historical information about the data traffic per radio network node, e.g., TRP. As a particular example, the one or more respective characteristics of the respective traffic may comprise Historical Mobility Propensity per TRP, from e.g., an AMF or an MME, as a List [TRPID, avg_camping_time, traffic_profile, [probability traffic distribution]].

With respect to the one or more respective characteristics of the respective traffic, the respective traffic may comprise current traffic. The one or more respective indications of the status of the one or more radio network nodes 110 with regard to respective traffic may comprise, for example, data traffic, aggregate or detailed per wireless device, on both uplink and downlink interface.

In some embodiments, as indicated above, the respective traffic may comprise current traffic and historical traffic. Optionally, the core network 120, may be consulted to retrieve historical information about the data traffic per radio network node, e.g., TRP.

The one or more respective characteristics of the respective traffic may comprise a respective type of traffic. The type of traffic may be, for example, video or audio, mission-critical control traffic, etc. It may be understood that for example, for video or audio traffic, some loss may be tolerated, whereas if the content is mission-critical control traffic, lower performing, but lossless algorithms, such as e.g., ZLIB, ZSTD, may be chosen.

The one or more respective characteristics of the respective traffic may comprise respective second information regarding respective one or more wireless devices 130 respectively served by the one or more radio network nodes 110.

The respective second information may comprise at least one of: a) respective mobility information, b) respective second capabilities of the one or more wireless devices 130 and c) a respective state of the respective radio link 160.

The respective mobility information may comprise, for example, mobility of the respective one or more wireless devices 130, e.g., indicated as Current mobility of UE. Direction of movement and velocity may also be used, if available.

The respective second capabilities may comprise current power status of a wireless device of the one or more wireless devices 130 with metrics such as battery state of charge and rate of discharge. Additionally, load-related information such as UE CPU and memory utilization, and radio bandwidth utilization may also be considered.

The respective state of the respective radio link 160 may comprise information about the channel state, such as Channel Quality Indicator (CQI) or channel state information (CSI) which may be reported.

In some embodiments, at least one of the following may apply. The first network node 101 may manage, or reside at, a macro cell and each of the one or more radio network nodes 110 may be TRPs. The first network node 101 may be the same node as the second network node 102. The respective link 140 may be wireless. The respective wireless link 140 may be a respective fronthaul link. The second network node 102 may have the backhaul link 144 to the core network 120. The communications network 100 may be a D-MIMO network.

Various compression methods may correspond to different compression ratios and type of compression, e.g., lossless or lossy- and in case of the latter percentage of loss, and therefore to different capacity requirements or availability on the respective link 140, e.g., the FH link, and different permissible noise or distortion levels on the data to be transmitted on the respective link 140, e.g., the FH data, being lossless or lossy. By obtaining the respective first information from the one or more radio network nodes 110 in this Action 201, the first network node 101 may then be enabled to determine what type of compression and/or decompression method to deploy, if needed and supported at what respective link 140, based on the collected respective first information. When different radio network nodes of the one or more radio network nodes 110, e.g., TRPs, may require different throughput on the backhaul link 144, e.g., due to serving a different number of users or due to serving users with different service types, the first network node 101 may then be enabled to select the proper compression and/or decompression algorithm for the respective link 140 between the respective radio network node, e.g., TRP, and the second network node 102, e.g., the macro node, by collecting relevant data from all the one or more radio network nodes 110. Embodiments herein may therefore enable to jointly optimize the compression and/or decompression selection and rate allocation for every respective link 140, e.g, TRP FH link, by collecting relevant data from all the one or more radio network nodes 110. Furthermore, the first network node 110 may be enabled to perform the selection of compression/decompression taking into consideration individual user traffic requirements, and computational capability and availability for compression/decompression activities, as well as the power consumption of endpoints.

### Action 202

In some embodiments, in this Action 202, the first network node 101 may determine, based on the obtained respective first information, a first predictive model of the respective traffic, e.g., respective data traffic, per radio network node of the one or more radio network nodes 110.

The determining in this Action 202 may be understood as calculating, deriving, estimating or similar. The determining in this Action 202 may comprise extracting a probability value distribution for data traffic per radio network node, e.g., TRP, based on aggregate traffic received in the previous Action 201. This extraction may also use historical data and, alternatively to probability distribution fitting, a regression may be used to fit current and historical data to a regression model. A model such as a regressor, may predict future UE mobility and data traffic profiles, and therefore it may provide lead-time for decision making in the determination and deployment of a compression algorithm, as will be described in Action 203 and Action 204, respectively.

A probability value distribution may be understood as a function that may describe the likelihood of every possible value of a random variable.

In particular examples, the first network node 101 may extract the probability value distribution from the Historical Mobility Propensity per radio network node, e.g., TRP, that may have been obtained in Action 201, from, for example, the core network 120, e.g., the AMF or the MME, as the List [TRP, avg_camping_time, traffic_profile, [probability traffic distribution]], or as a List [TRPID, PVD].

In some embodiments, the determining in this Action 202 of the first predictive model may be performed using machine learning (ML).

The ML algorithm that may be used for the determining in this Action 202 may be any of proactive or reactive in nature and may involve supervised/unsupervised/RL algorithms to be able to predict the respective traffic.

The determining in this Action 202 of the one or more ML models may comprise a training phase, during which the first predictive model may be trained, and an inference phase.

The training during the training phase may be performed iteratively, with each pool of additionally collected respective first information.

The inference phase may be understood as a phase wherein the first predictive model may be executed, or used, to make a particular prediction. The inference phase may be reached once a desired accuracy level of the first predictive model may have been reached.

By, in this Action 202, determining the first predictive model of the respective traffic, the first network node 101 may be enabled to gain lead-time for decision making in the determination and deployment of a compression and/or decompression algorithm, as will be described in Action 203 and Action 204, respectively. This may be understood to be since the first network node 101 may not need to wait for the respective traffic data and may instead rely on the first predictive model to provide a respective prediction on the respective traffic, based on which the first network node 101 may then select which compression and/or decompression type to use. Knowing in advance when data/how much data will be transmitted, may be understood to enable the first network node 101 to understand the utilization of a link and as such, determine how/when/how much to compress that traffic.

### Action 203

In this Action 203, the first network node 101 determines, based on the obtained respective first information, a respective type of compression and/or decompression, e.g., a particular compression and/or decompression algorithm. The respective type of compression and/or decompression is to be applied to the respective traffic in the respective link 141 between at least the first radio network node 111 of the one or more radio network nodes 110 and the second network node 102.

That the determining is based on the obtained respective first information may comprise that the determination may be performed taking into consideration individual user traffic requirements, as well as computational capability and availability for compression/decompression activities, as well as the power consumption of endpoints. That is, the decision may be based on, for example, on the current status of the first radio network node 111, e.g., TRP, TRP capabilities, current and historical traffic profile, e.g., TRP1, macro, Auto Encoder (AE), downlink, and mobility data of the one or more wireless devices 130 obtained in Action 201.

As explained earlier, various compression methods may correspond to different compression ratios, and therefore to different capacity requirements or availability on the respective link 140, e.g., the FH link, and different permissible noise or distortion levels on the data to be transmitted on the respective link 140, e.g., the FH data, being lossless or lossy. By the determining being based on the obtained respective first information, the first network node 101 may then be enabled to determine which respective link 140 may have what type of compression and/or decompression. That is, what type of compression and/or decompression method to deploy, if needed and supported at what respective link 140, e.g., TRP-macro link, but also for what direction of traffic, downlink and/or uplink, based on the collected respective first information.

Different compression methods that may be chosen in the determining in this Action 203 may comprise: autoencoders or variational autoencoders of different complexity, e.g., different number of layers, neurons per layer. More complex models in general may allow for a more compact latent space representation, that is, a higher compression, and lower information loss but at the same time may require more computational capabilities and memory.

The determining in this Action 203 may comprise using the required UE link robustness or data fidelity class, e.g., associated with the traffic type, to select between lossless and lossy compression methods, as well as to select a method with a permissible information loss level. The first network node 101 may achieve a specified trade-off between compression complexity, efficiency, and fidelity under the given system scenarios and channel conditions.

Algorithms that may be used are listed in Table 1. Table 1 depicts a non-exhaustive sample of compression algorithms that may be used in embodiments herein, ranked by compression/decompression time and file size, as described by Zhang, Zhe & Bockelman, Brian (2017) in Exploring compression techniques for ROOT IO, Journal of Physics: Conference Series, 898, 10.1088/1742-6596/898/7/072043. The algorithms may vary in terms of computational requirements, time to compress but also compression performance.

TABLE 1
Types of compression and/or decompression

| | Compression | Decompression | Compressed | Compression |
|---|---|---|---|---|
| Algorithm | Time (s) | Time (s) | File Size (GB) | Ratio |
| ROOT(ZLIB-6) | 228. [symbol] 7 | 18.4 [symbol] | 1.5 [symbol] | 4.1 [symbol] |
| ZLIB-1 | 86.47 | 21. [symbol] 1 | 1.79 | 3. [symbol] 8 |
| ZLIB-5 | 1 [symbol] .84 | 19.2 [symbol] | 1. [symbol] 8 | 4. [symbol] |
| ZLIB-9 | 1715.25 | 18.2 [symbol] | 1. [symbol] | 4.3 [symbol] |
| LZ4 | 11.2 [symbol] | 2. [symbol] 7 | 2.17 | 2. [symbol] |
| LZ4 [symbol] -5 | 9 [symbol] .13 | 2. [symbol] 1 | 1.75 | 3. [symbol] |
| LZ4 [symbol] -9 | 27 [symbol] .31 | 2. [symbol] 4 | 1. [symbol] | 3. [symbol] |
| LZMA-1 | 823. [symbol] 4 | 23 [symbol] . [symbol] 4 | 1.3 [symbol] | 4.74 |
| LZMA-5 | 3318.35 | 211.71 | 1.23 | [symbol] .2 [symbol] |
| LZMA-9 | [symbol] 69.2 [symbol] | 212.47 | 1.2 [symbol] | [symbol] .2 [symbol] |

[symbol]

indicates data missing or illegible when filed

Examples of compression algorithms may be lossless algorithms, e.g., ZLIB, ZSTD, and lossy autoencoders, e.g., an autoencoder, “AE1”, comprising a simple 2-layer structure for its encoder and its decoder, with one fully connected layer, each “Dense” as it may be understood to be called in tensorflow, and another autoencoder, “AE2”, comprising 12 encoder layers and 14 decoder layers, with 4 and 5 fully connected layers respectively. The different types of compression and/or decompression, e.g, encoders/decoders, may show different characteristics, which may be taken into consideration in the determination performed in this Action 203. For example, autoencoders may provide higher compression ratios than ZLIB, ZSTD, but experience loss. If trained correctly, and depending on the application, this loss may be acceptable. For example, if the content being transmitted or received to/from the one or more wireless devices 130 is video or audio, some loss may be tolerated. If the content is mission-critical control traffic, then lower performing, but lossless ZLIB, ZSTD algorithms may be chosen.

Autoencoders may also have lower latency for the same volume of data than their ZLIB, ZSTD counterparts. Therefore, if latency is a concern, a high-performing autoencoder with acceptable levels of reconstruction loss may be preferred to lossless algorithms.

ZLIB, ZSRD may perform considerably better, in terms of compression ratio, in relation to encoding pieces of text rather than binary data such as images. This may also be considered for cases where data traffic consists of textual payloads.

In some examples, a representation suitable for processing in a spike neural network may be obtained by way of rate encoding, latency encoding or delta modulation, e.g., for the representation of a time series representing traffic. That is, in the case of spike neural networks, the choice may be to choose rate encoding as a “compression” technique before the transmission and then let the receiver consume that input directly, without decoding, by using the corresponding spiking neural network.

In some examples, the decision in this Action 203 may also concern specific flows in the uplink or downlink direction, said flows described for example by packet filters. One such filter that may be used may be a Service Data Flow (SDF), which may be also used in Policy Charging and Control (PCC) rules in the policy node of the core network 120.

In some embodiments, the determining in this Action 203 of the respective type of compression and/or decompression may be further based on the determined first predictive model. That is, the decision may be based on the regression/probability value distribution traffic model extracted in Action 202, the advantages of which have already been explained earlier.

In some embodiments, the determining in this Action 203 of the respective type of compression and/or decompression may be based on the respective first information obtained from a plurality or the totality of the radio network nodes 110.

The determining in this Action 203 of the respective type of compression and/or decompression may be at least one of the following. In some embodiments, it may be based on a load, herein referred to as “second load”, of the second network node 102.

In some embodiments, the determining in this Action 203 of the respective type of compression and/or decompression may be performed for a subset of the one or more radio network nodes 110 for a same or overlapping time period. That is, the first network node 101 may determine the respective type of compression and/or decompression to be applied to the respective traffic in the respective link 140 between a respective radio network node of the one or more radio network nodes 110 and the second network node 102, for other radio network nodes than the first radio network node 111.

In some embodiments, the determining in this Action 203 of the respective type of compression and/or decompression may be based on a status of a receiver of the, e.g., compressed, traffic.

The one or more respective indications of the status of the one or more radio network nodes 110 may be considered to be one or more respective first indications of a first status of the one or more radio network nodes 110, In some of such embodiments, the determining in this Action 203 of the respective type of compression and/or decompression may be based on one or more second respective indications of a second status of the second network node 102. The one or more second respective indications of the second status of the second network node 102 may be described as the one or more respective first indications, but for the second network node 102. The second network node 102 may, in some examples, be the receiver of the, e.g., compressed traffic. In some examples, the receiver may be any of the one or more radio network nodes 110, e.g., the first radio network node 111.

In some embodiments, the determining in this Action 203 of the respective type of compression and/or decompression may be performed using machine learning. In some embodiments, the determining in this Action 203 of the respective type of compression and/or decompression may be performed using reinforcement learning by one or more agents.

In some examples, the approach that may be followed by the first network node 101 towards training a machine learning algorithm for the determining performed in this Action 203 may be to use deep reinforcement learning, wherein an intelligent agent may learn to take optimal actions in an environment, given a state of this environment, also known as Markov Decision Process (MDP). Optimality may be decided by a reward, a scalar returned by the environment, together with a new state, which may be understood to be a result of the action taken by the agent. For example, in RL, e.g., Deep Q Network (DQN), the goal or objective function, may be to predict the action that may yield the highest reward, discounted by gamma for a given state Q(s,a). The action may be the type of compression. By measuring the reward of that action, the agent may learn to choose the optimal action. For example, if the agent selects a computationally expensive action when there may be not enough compute resources, it may get punished. Therefore, the next time it may learn to predict that such an action yields low reward and, as such, refrain from performing that action.

In other examples, the determining in this Action 203 of the respective type of compression and/or decompression may be performed, instead of by machine learning, by way of a set of rules, e.g., if traffic is high and compute load, use z-standard. Another option may be by negotiation. For example, the receiver may be inquired about what kind of decompression it may support and as such, the appropriate compression may be chosen.

In embodiments herein, the state of the environment may be the respective first information collected in Action 201, and optionally processed data in Action 202. The action, depending on the embodiment, may be the selection of a compression algorithm to use on the respective link 140, or a combination of the selection function and allocated rate. The agent may work on a single point-to-point respective link 140, that is, fronthaul link, or multiple links. The reward may be parameterized by the packet loss rate and latency on the respective link 140, because of the action taken by the agent.

As explained earlier for the determining performed in Action 202, the determining in this Action 203 using ML may comprise a training phase, during which the an ML model may be trained, and an inference phase.

The training during the training phase may be performed iteratively, with each pool of additionally collected respective first information.

The inference phase may be understood as a phase wherein the ML model may be executed, or used, to make a particular prediction. The inference phase may be reached once a desired accuracy level of the ML model may have been reached.

In particular embodiments, the determining in this Action 203 of the respective type of compression and/or decompression may be performed by a plurality of agents, each performing the determining in this Action 203 of the respective type of compression and/or decompression for a respective radio network node 110. In multi agent RL, more than one agent may work together towards a common global reward and, as such, the plurality of agents may learn to pick an action that may maximize the global reward, e.g., by taking into consideration the actions of other agents.

In some embodiments, in addition to determining the respective type of compression and/or decompression, the first network node 101 may determine an adaptation of a coding rate that may have to be used when applying the compression and/or decompression of the respective type. For example, in some embodiments, the expected information loss in a lossy compression approach, e.g., when applying an auto-encoder, may be accounted for during the Modulation and Coding Scheme (MCS) selection, e.g., channel coding rate selection, step of data scheduling. The information loss in fronthaul may be compensated by appropriately lowering the assumed mutual information, that is, an information-theoretic metric reflecting channel quality of the respective radio link 160, normally based solely on CSI reporting, and applying a more robust MCS, e.g., lower-rate coding.

Hence the determining of the respective type of compression and/or decompression to be applied to the respective traffic in the respective link 141 may be further based on the determined adaptation of the coding rate, e.g., determined jointly with the respective type of compression and/or decompression, based on the determined adaptation of the coding rate and the obtained respective first information. In such embodiments, in the data collection phase, the service/rate requirements of the wireless devices connected to the one or more radio network nodes 110, e.g., one radio network node of the one or more radio network nodes 110, may be collected, in addition to the data being collected. The first network node 101 may then be enabled to allocate the determined rates to the respective links 140, e.g., the FH links, based on which a compression and/or decompression scheme may be selected for that link. There may be multiple ways to control the rate of various respective links 140, e.g., the FH links, including power allocation from the second network node 102 toward various radio network nodes of the one or more radio network nodes 110.

By determining the respective type of compression and/or decompression to be applied to the respective traffic in the respective link 141 between at least the first radio network node 111 of the one or more radio network nodes 110 and the second network node 102 in this Action 203, the first network node 101 may be enabled to perform a joint optimization of the compression and/decompression selection and optionally, rate allocation, for every respective link 140, e.g., TRP FH link. When different radio network nodes of the one or more radio network nodes 110, e.g., TRPs, may require different throughput on the backhaul link 144, e.g., due to serving a different number of users or due to serving users with different service types, the first network node 101 may then be enabled to select the proper compression and/or decompression algorithm for the respective link 140 between the respective radio network node, e.g., TRP, and the second network node 102, e.g., the macro node, by relying on the respective first information collected from all the one or more radio network nodes 110. Embodiments herein may therefore enable to jointly optimize the compression and/or decompression selection and rate allocation for every respective link 140, e.g, TRP FH link, by performing the determination using the respective first information collected from all the one or more radio network nodes 110. Furthermore, the first network node 101 may be enabled to perform the selection of compression/decompression taking into consideration individual user traffic requirements, as well as computational capability and availability for compression/decompression activities, as well as the power consumption of endpoints. As stated earlier, a multi agent RL approach may be used whereby more than one agent may work together towards a common global reward and, as such, the agents may learn to pick an action that may maximize global reward, e.g., by taking into consideration the actions of other agents. Agents may otherwise be “selfish” and, as such, take actions that even though yield high reward for themselves, may negatively impact other agents, e.g., TRPs or APs. Joint optimization may yield more optimal decisions.

### Action 204

In this Action 204, the first network node 101 initiates application of the compression and/or decompression of the determined respective type to the respective traffic in the respective link 141.

Initiating may be understood as starting itself, triggering, e.g., instructing another network node to, or enabling.

The initiating in this Action 204 the application of the compression and/or decompression of the determined respective type may comprise at least one of the following two options. In some embodiments, the initiating may comprise application of the compression and/or decompression of the determined respective type by the second network node 102. This may be performed, for example, in embodiments wherein the first network node 101 may enable the first radio network node 111 and/or the second network node 102 to apply compression and/or decompression.

Application of the compression and/or decompression of the determined respective type may comprise deployment of the determined compression and/or decompression algorithm. For example, different autoencoders may be stored in a Model Repository (MR) and one of them may be fetched and deployed at a respective link 140. However, more compression algorithms may also be considered, e.g., lossy/lossless, probability coding, sliding window based compression, etc.

In some embodiments, the initiating may comprise sending a respective first indication to at least another network node 102, 110, 111. The another network node 102, 110, 111 may be one of a) the first radio network node 111 of the one or more radio network nodes 110, and b) the second network node 102. The respective first indication may indicate the determined type of compression and/or decompression. This may be performed, for example, in embodiments wherein the first network node 101 may be a different node than the second network node 102 and may communicate to the second network node 102 how to apply decompression and/or compression, for example, which algorithm, and on which respective link 140. In other embodiments, the first network node 101 may send the respective first indication when it may be the same node as the second network node 102, e.g., a CPU in a D-MIMO network, and it may communicate to the first radio network node 111 how to apply compression and/or decompression.

In some examples, the respective first indication may further indicate the adaptation of the coding rate that may have to be used when applying the compression and/or decompression of the respective type.

Optionally, additional error correction codes may also be deployed if the interference of the respective link 140, e.g., wireless channel, may be too great, or rate allocation on the fronthaul reduces the interference.

By initiating application of the compression and/or decompression of the determined respective type to the respective traffic in the respective link 141 in this Action 204, the first network node 101 may enable the another node 102, 110, 111 to then use or cause to use a compression and/or decompression method and, optionally, rate adaptation, for at least one or, e.g., multiple, FH links, considering computational capability and power consumption of endpoints, status of the FH wireless channel, predicted throughput and mobility patterns. This may be understood to be particularly relevant for embodiments wherein the one or more radio network nodes 110 may have limited capabilities with respect to other radio network nodes, e.g., may be TRPs, which may be comparatively low cost and have limited computational capabilities, and therefore not capable to apply any type of compression and/or decompression. Hence, transmission of information in the communications network 100 may be optimized, as a compression type may be chosen that may decrease the volume of data that may need to be transmitted, without delaying the transmission or using more compute than may be available, or creating any overhead on the receiver that may need to decompress the data.

Embodiments of a computer-implemented method, performed by the another node 102, 110, 111, will now be described with reference to the flowchart depicted in FIG. 3. The method is for handling the compression of traffic. The another node 102, 110, 111 operates in the communications network 100.

Several embodiments are comprised herein. In some embodiments all the actions may be performed. In some embodiments, some actions may be optional. In FIG. 3, an optional action is indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. The detailed description of some of the following corresponds to the same references provided above, in relation to the actions described for the first network node 101 and will thus not be repeated here. For example, in some embodiments, the communications network 100 may be a D-MIMO network.

### Action 301

In this Action 301, the another node 102, 110, 111 may send the respective first information from at least the first radio network node 111 of the one or more radio network nodes 110, to the first network node 101.

The respective first information may indicate: i) the one or more respective indications of the status of the one or more radio network nodes 110, and ii) the one or more respective characteristics of the respective traffic between the one or more radio network nodes 110 and the second network node 102.

In some embodiments, at least one of the following options may apply. According to a first option, the one or more respective indications of the status of the one or more radio network nodes 110 may be associated to the respective identifier of the one or more radio network nodes 110. According to a second option, the one or more respective indications of the status of the one or more radio network nodes 110 may comprise at least one of the following: i) the respective one or more indicators of the hardware status of the one or more radio network nodes 110 comprising the one or more of indicators: computational, memory and power, ii) the respective current camping time of the respective set 131, 132, 133 of the one or more wireless devices 130 served by the respective one or more radio network nodes 110, iii) the respective first load of the one or more radio network nodes 110, and iv) the respective historical mobility propensity of the one or more radio network nodes 110. According to a third option, the one or more respective characteristics of the respective traffic may comprise the respective type of traffic. According to a fourth option, the one or more respective characteristics of the respective traffic may comprise the respective second information regarding the respective one or more wireless devices 130 respectively served by the one or more radio network nodes 110. According to a fifth option, the respective second information may comprise at least one of: a) the respective mobility information, b) the respective second capabilities of the one or more wireless devices 130, and c) the respective state of the respective radio link 160.

In some embodiments, at least one of the following options may apply. According to a first option, the another network node 102, 110, 111 may be one of a) the first radio network node 111 of the one or more radio network nodes 110 and b) the second network node 102. According to a second option, the respective traffic may comprise current traffic. According to a third option, the respective traffic may comprise current traffic and historical traffic. According to a fourth option, the first network node 101 may manage the macro cell and each of the one or more radio network nodes 110 may be TRPs. According to a fifth option, the first network node 101 may be the same node as the second network node 102. According to a sixth option, the respective link 140 may be wireless. According to a seventh option, the respective wireless link 140 may be the respective fronthaul link. According to an eighth option, the second network node 102 may have the backhaul link 144 to the core network 120. According to a ninth option, the communications network 100 may be a D-MIMO network.

### Action 302

In this Action 302, the another node 102, 110, 111 obtains the respective first indication from the first network node 101 operating in the communications network 100. The respective first indication indicates the respective type of compression and/or decompression to be applied to the respective traffic in the respective link 141 between the respective radio network node of one or more radio network nodes 110 and the second network node 102 operating in the communications network 100. The one or more radio network nodes 110 have access to the core network 120 of the communications network 100 via the respective link 140 to the second network node 102. The respective type of compression is based on the respective first information. The respective first information indicates: i) the one or more respective indications of the status of the one or more radio network nodes 110, and ii) the one or more respective characteristics of the respective traffic between the one or more radio network nodes 110 and the second network node 102.

The obtained respective first indication may be based on the sent respective first information.

The respective type of compression and/or decompression may be at least one of: a) based on the second load of the second network node 102, b) based on the respective first information obtained from the plurality or the totality of the radio network nodes 110, c) based on the one or more second respective indications of the second status of the second network node 102, wherein the one or more respective indications of the status of the one or more radio network nodes 110 may be the one or more respective first indications of the first status of the one or more radio network nodes 110, d) performed for the subset of the one or more radio network nodes 110 for the same or overlapping time period, e) determined using machine learning, f) determined using reinforcement learning by the one or more agents, g) determined by the plurality of agents, each performing the determining of the respective type of compression and/or decompression for the respective radio network node 110.

In some embodiments, the respective first indication may be further based on the determined first predictive model of the respective traffic per radio network node of the one or more radio network nodes 110.

In some embodiments, the respective first indication may further indicate the adaptation of the coding rate that may have to be used when applying the compression and/or decompression of the respective type.

### Action 303

In this Action 303, the another node 102, 110, 111 initiates application of the compression and/or decompression of the determined respective type to the respective traffic in the respective link 141.

In some embodiments, initiating in this Action 303 the application of the compression and/or decompression of the determined respective type may comprise one of: a) the application of the compression and/or decompression of the determined respective type by the second network node 102 or at least the first radio network node 111 of the one or more radio network nodes 110, and b) sending at least a third indication indicating the obtained respective first indication to the at least the first radio network node 111 of the one or more radio network nodes 110.

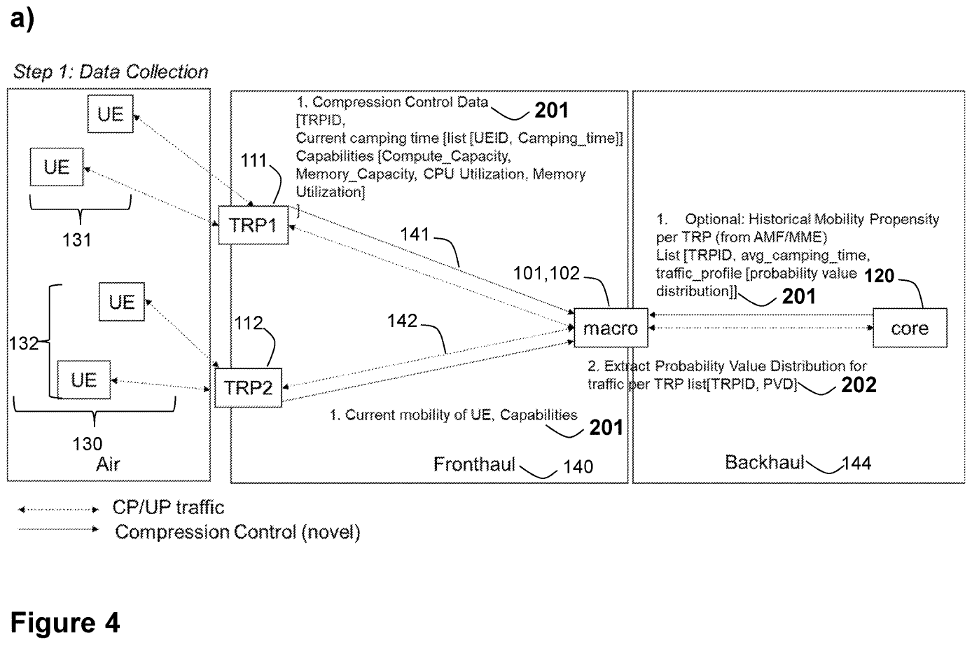

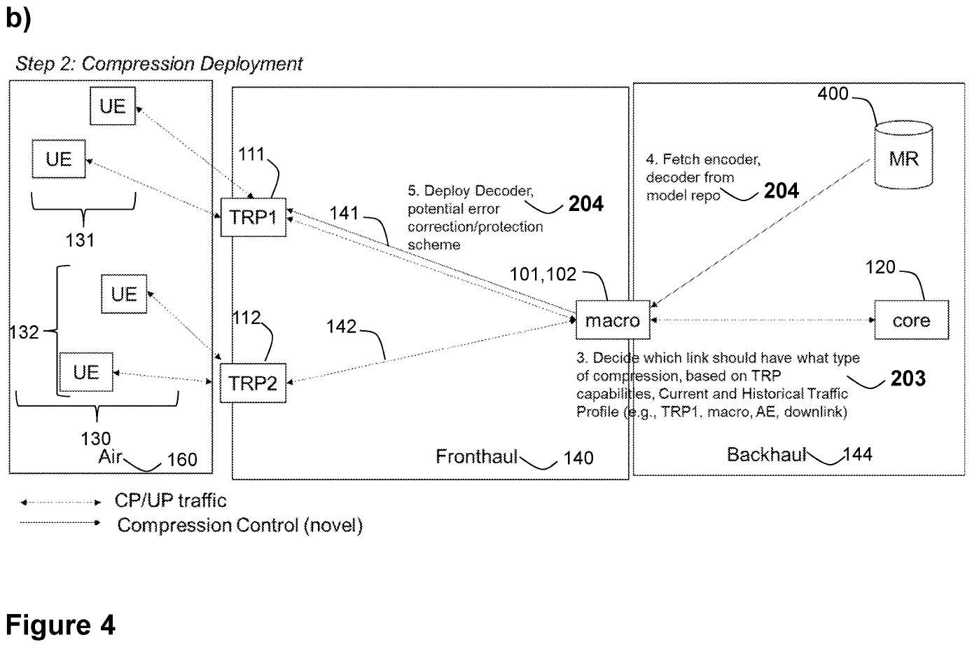

FIG. 4 is a schematic diagram depicting a non-limiting example of the method performed by the first network node 101, according to embodiments herein. In this example, the first network node 101 is the same node as the second network node 102 and manages a macro cell in a D-MIMO deployment. The one or more radio network nodes 110 are TRPs and comprise the first radio network node 111 as a first TRP, TRP1, and the second radio network node 112 as a second TRP, TRP2. The one or more wireless devices 130 comprise four UEs. TRP1 serves the first set 131 of wireless devices comprising two UEs, and the TRP2 serves the second set 132 of wireless devices comprising other two other UEs. FIG. 4 depicts the respective radio links 160 going over the air interface between the UEs and the respective TRPs, as well as the FH comprising the respective links 140, particularly, the first respective link 141 and the second respective link 142. FIG. 4 also depicts the backhaul link 144. Further particularly depicted is the Control Plane (CP) and User Plane (UP) traffic, in dashed arrows, as well as the exchange of information corresponding to the actions performed according to embodiments herein, for the determination of the compression and/or decompression type to be applied at the first respective link 141, indicated by the solid arrows. Panel a) of FIG. 4 depicts a first step, Step 1. In this step, at 1, the first network node 101 may, according to Action 201, collect the respective first information from every TRP. This respective first information may be three-fold. The respective first information may indicate the status of the respective TRP, that may include CPU load, e.g., percentage of total, memory utilization, e.g., percentage of total, compute capacity, e.g., in terms of FLOPS, memory capacity, e.g., in GB, but also power characteristics such as power source, e.g., power grid/renewables, current power supply and consumption, e.g., in W, and battery DoD and/or SoC, e.g., as percentage. The respective first information may comprise UE information, such as average, or detailed if available, cell camping time and data traffic, aggregate or detailed per UE, e.g., identified by an UEID, on both uplink and downlink interface. This respective first information is indicated in FIG. 4 as “Compression Control Data”, including: [TRPID, Current camping time [list [UEID, Camping_time]] Capabilities [Compute_Capacity, Memory_Capacity, CPU Utilization, Memory Utilization]]. Additionally, mobility of UE including direction of movement and velocity may also be used, if available. Information about the channel state such as CQI or CSI may be reported as well. Optionally, the core network 120 and OAM node may be consulted to retrieve historical information about the data traffic per TRP as well. This may be comprised in the respective first information. As the respective first information may be reported per TRP, a TRP identifier, e.g., TRP ID, which may uniquely identify the TRP to the first network node 101, may be used. An example of such identifier may be the MAC address of the TRP radio interface. This respective first information is indicated in FIG. 4 as “Historical Mobility Propensity per TRP (from AMF/MME) List [TRPID, avg_camping_time, traffic_profile [probability value distribution]]”. At 2, in accordance with Action 202, the first network node 101 may extract the probability value distribution for data traffic per TRP, based on aggregate traffic received in the previous step. This extraction may also use historical data and alternatively to probability distribution fitting, a regression may be used to fit current and historical data to a regression model. A model such as a regressor may predict future UE mobility and data traffic profiles, and therefore it may provide lead-time for decision making at 3 and deployment of compression algorithm in at 4 and 5, which are depicted in panel b). Panel b) of FIG. 4 depicts a second step, Step 2. In this step, at 3, the first network node 101 may decide, according to Action 203, what type of compression method to deploy, if needed and supported at what respective link 140, that is, network, TRP-macro, link between, specifically, the second network node 102 and the first radio network node 111, but also at what direction of traffic, downlink and/or uplink. In another example, the decision may also concern specific flows in the uplink or downlink direction, said flows described for example by packet filters. One such filter that may be used is SDF, which may be also used in PCC rules in the policy node of the core network 120. The decision may be based on the regression/probability value distribution traffic model extracted at 2, as well as the current status of the TRP and mobility UE data extracted in step 1. The required UE link robustness or data fidelity class, e.g., associated with the traffic type, may be used to select between lossless and lossy compression methods, as well as to select a method with a permissible information loss level. The selection method may provide a specified trade-off between compression complexity, efficiency, and fidelity under the given system scenarios and channel conditions. The deployment of the selected algorithm in accordance with Action 204 is depicted at 4-5. At 4, the first network node 101 may fetch one of the autoencoders or decoders from a model repository (MR) 400, where different autoencoders may be stored. At 5, the autoencoder fetched at 5 is deployed at a TRP, macro link, particularly, the first respective link 141; however, more compression algorithms may also be considered as discussed at 3. It may be noted by the solid arrows in the fronthaul box, that while the first respective information may be collected from all the TRPs, the determination of the compression and/or decompression type may be made, e.g., optimized, for the respective link 141 individually.

As a summarized overview of the foregoing, embodiments herein may be understood to enable selection of a compression and/or decompression method and rate adaptation for multiple FH links, considering computational capability and power consumption of endpoints, status of the FH wireless channel, predicted throughput and mobility patterns.

Certain embodiments herein may provide one or more of the following technical advantage(s). A first technical advantage may be understood to be that the selection of compression and/or decompression disclosed may consider capacity of the endpoints in FH compression and/or decompression for deploying compression and/or decompression algorithms and performing rate adaptation. This may be particularly relevant for TRPs which may be comparatively low cost and have limited computational capabilities. As a second technical advantage, embodiments herein may be understood to enable to optimize jointly multiple FH links, which may be better suited to multi-connectivity technologies such as D-MIMO. D-MIMO may be understood to inherently have many FH links, whereas traditional deployments may be understood to often have only one.

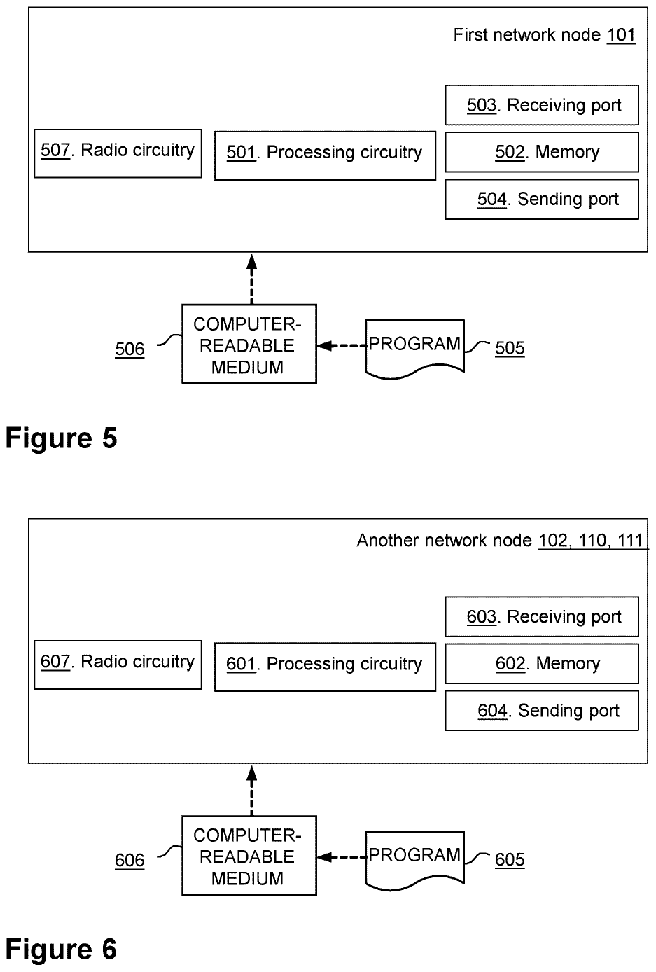

FIG. 5 depicts an example of the arrangement that the first network node 101 may comprise to perform the method described in in FIG. 2 and/or FIG. 4. The first network node 101 may be understood to be for handling compression of traffic. The first network node 101 is configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 101 and will thus not be repeated here. For example, in some embodiments, the communications network 100 may be a D-MIMO network.

The first network node 101 is configured to obtain the respective first information from the one or more radio network nodes 110. The one or more radio network nodes 110 are configured to have access to the core network 120 of the communications network 100 via the respective link 140 to the second network node 102 configured to operate in the communications network 100. The respective first information is configured to indicate: i) the one or more respective indications of the status of the one or more radio network nodes 110, and ii) the one or more respective characteristics of the respective traffic between the one or more radio network nodes 110 and the second network node 102.

The first network node 101 is also configured to determine, based on the respective first information configured to be obtained, the respective type of compression and/or decompression to be applied to the respective traffic in the respective link 141 between at least the first radio network node 111 of the one or more radio network nodes 110 and the second network node 102.

The first network node 101 is further configured to initiate application of the compression and/or decompression of the respective type configured to be determined, to the respective traffic in the respective link 141.

In some embodiments, the first network node 101 may be further configured to determine, based on the respective first information configured to be obtained, the first predictive model of the respective traffic per radio network node of the one or more radio network nodes 110. The determining of the respective type of compression and/or decompression may be configured to be further based on the first predictive model configured to be determined.

In some embodiments, the determining of the first predictive model may be configured to be performed using machine learning.

In some embodiments, initiating the application of the compression and/or decompression of the respective type configured to be determined may be configured to comprise at least one of: a) application of the compression and/or decompression of the respective type configured to be determined by the second network node 102, and b) sending the respective first indication to at least another network node 102, 110, 111. The another network node 102, 110, 111 may be configured to be one of: a) the first radio network node 111 of the one or more radio network nodes 110 and b) the second network node 102. The respective first indication may be configured to indicate the type of compression and/or decompression configured to be determined.

In some embodiments, at least one of the following options may apply. According to a first option, the one or more respective indications of the status of the one or more radio network nodes 110 may be configured to be associated to the respective identifier of the one or more radio network nodes 110. According to a second option, the one or more respective indications of the status of the one or more radio network nodes 110 may be configured to comprise at least one of: i) the respective one or more indicators of the hardware status of the one or more radio network nodes 110 comprising the one or more indicators of: computational, memory and power, ii) the respective current camping time of the respective set 131, 132, 133 of the one or more wireless devices 130 configured to be served by the respective one or more radio network nodes 110, iii) the respective first load of the one or more radio network nodes 110, and iv) the respective historical mobility propensity of the one or more radio network nodes 110. According to a third option, the respective traffic may be configured to comprise current traffic. According to a fourth option, the respective traffic may be configured to comprise current traffic and historical traffic. According to a fifth option, the one or more respective characteristics of the respective traffic may be configured to comprise the respective type of traffic. According to a sixth option, the one or more respective characteristics of the respective traffic may be configured to comprise the respective second information regarding the respective one or more wireless devices 130 configured to be respectively served by the one or more radio network nodes 110. According to a seventh option, the respective second information may be configured to comprise at least one of: a) the respective mobility information, b) the respective second capabilities of the one or more wireless devices 130, and c) the respective state of the respective radio link 160.

In some embodiments, the determining of the respective type of compression and/or decompression may be configured to be at least one of: a) based on the second load of the second network node 102, b) based on the respective first information configured to be obtained from the plurality or the totality of the radio network nodes 110, c) based on the one or more second respective indications of the second status of the second network node 102, wherein the one or more respective indications of the status of the one or more radio network nodes 110 may be configured to be the one or more respective first indications of the first status of the one or more radio network nodes 110, d) performed for the subset of the one or more radio network nodes 110 for the same or overlapping time period, e) performed using machine learning, f) performed using reinforcement learning by the one or more agents, and g) performed by the plurality of agents, each configured to determine the respective type of compression and/or decompression for a respective radio network node 110.

In some embodiments, at least one of the following may apply: a) the first network node 101 may be configured to manage the macro cell and each of the one or more radio network nodes 110 may be configured to be TRPs, b) the first network node 101 may be configured to be the same node as the second network node 102, c) the respective link 140 may be configured to be wireless, d) the respective wireless link 140 may be configured to be the respective fronthaul link, e) the second network node 102 may be configured to have the backhaul link 144 to the core network 120, and f) the communications network 100 may be configured to be the D-MIMO network.

In some embodiments, the first network node 101 may be further configured to determine the adaptation of the coding rate that may have to be used when applying the compression and/or decompression of the respective type, and the determining of the respective type of compression and/or decompression to be applied to the respective traffic in the respective link 141 may be further configured to be based on the adaptation of the coding rate configured to be determined.

The embodiments herein in the first network node 101 may be implemented through one or more processors, such as a processing circuitry 501 in the first network node 101 depicted in FIG. 5, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 101. One such carrier may be in the form of a CD ROM disc. It is however feasible with other data carriers such as a memory stick. The computer program code may furthermore be provided as pure program code on a server and downloaded to the first network node 101.

The first network node 101 may further comprise a memory 502 comprising one or more memory units. The memory 502 is arranged to be used to store obtained information, store data, configurations, schedulings, and applications etc. to perform the methods herein when being executed in the first network node 101.

In some embodiments, the first network node 101 may receive information from, e.g., the another node 102, 110, 111, e.g., the second network node 102, the core network 120, the one or more radio network nodes 110, e.g., the first radio network node 111, the one or more wireless devices 130, and/or another structure in the wireless communications network 100, through a receiving port 503. In some embodiments, the receiving port 503 may be, for example, connected to one or more antennas in first network node 101. In other embodiments, the first network node 101 may receive information from another structure in the wireless communications network 100 through the receiving port 503. Since the receiving port 503 may be in communication with the processing circuitry 501, the receiving port 503 may then send the received information to the processing circuitry 501. The receiving port 503 may also be configured to receive other information.

The processing circuitry 501 in the first network node 101 may be further configured to transmit or send information to e.g., the second network node 102, the core network 120, the one or more radio network nodes 110, e.g., the first radio network node 111, the one or more wireless devices 130, and/or another structure in the wireless communications network 100, through a sending port 504, which may be in communication with the processing circuitry 501, and the memory 502.

Those skilled in the art will also appreciate that the units comprised within the first network node 101 described above as being configured to perform different actions, may refer to a combination of analog and digital circuits, and/or one or more processors configured with software and/or firmware, e.g., stored in memory, that, when executed by the one or more processors such as the processing circuitry 501, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip.

Also, in some embodiments, the different units comprised within the first network node 101 described above as being configured to perform different actions described above may be implemented as one or more applications running on one or more processors such as the processing circuitry 501.

Thus, the methods according to the embodiments described herein for the first network node 101 may be respectively implemented by means of a computer program 505 product, comprising instructions, i.e., software code portions, which, when executed on at least one processing circuitry 501, cause the at least one processing circuitry 501 to carry out the actions described herein, as performed by the first network node 101. The computer program 505 product may be stored on a computer-readable storage medium 506. The computer-readable storage medium 506, having stored thereon the computer program 505, may comprise instructions which, when executed on at least one processing circuitry 501, cause the at least one processing circuitry 501 to carry out the actions described herein, as performed by the first network node 101. In some embodiments, the computer-readable storage medium 506 may be a non-transitory computer-readable storage medium, such as a CD ROM disc, or a memory stick. In other embodiments, the computer program 505 product may be stored on a carrier containing the computer program 505 just described, wherein the carrier is one of an electronic signal, optical signal, radio signal, or the computer-readable storage medium 506, as described above.

The first network node 101 may comprise a communication interface configured to facilitate, or an interface unit to facilitate, communications between the first network node 101 and other nodes or devices, e.g., the second network node 102, the core network 120, the one or more radio network nodes 110, e.g., the first radio network node 111, the one or more wireless devices 130, and/or another structure in the wireless communications network 100. The interface may, for example, include a transceiver configured to transmit and receive radio signals over an air interface in accordance with a suitable standard.

In other embodiments, the first network node 101 may comprise a radio circuitry 507, which may comprise e.g., the receiving port 503 and the sending port 504.

The radio circuitry 507 may be configured to set up and maintain at least a wireless connection with the second network node 102, the core network 120, the one or more radio network nodes 110, e.g., the first radio network node 111, the one or more wireless devices 130, and/or another structure in the wireless communications network 100. Circuitry may be understood herein as a hardware component.

Hence, embodiments herein also relate to the first network node 101 operative to operate in the wireless communications network 100. The first network node 101 may comprise the processing circuitry 501 and the memory 502, said memory 502 containing instructions executable by said processing circuitry 501, whereby the first network node 101 is further operative to perform the actions described herein in relation to the first network node 101, e.g., in FIG. 2 and/or FIG. 4.

FIG. 6 depicts an example of the arrangement that the another node 102, 110, 111 may comprise to perform the method described in FIG. 3 and/or FIG. 4. The another node 102, 110, 111 may be understood to be for handling the compression of traffic. The another node 102, 110, 111 is configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the another network node 102, 110, 111 and will thus not be repeated here. For example, in some embodiments, the communications network 100 may be a D-MIMO network.

The another node 102, 110, 111 is configured to obtain the respective first indication from the first network node 101 configured to operate in the communications network 100. The respective first indication is configured to indicate the respective type of compression and/or decompression to be applied to the respective traffic in the respective link 141 between the respective radio network node of one or more radio network nodes 110 and the second network node 102 configured to operate in the communications network 100. The one or more radio network nodes 110 are further configured to have access to the core network 120 of the communications network 100 via the respective link 140 to the second network node 102. The respective type of compression is configured to be based on the respective first information. The respective first information is configured to indicate: i) the one or more respective indications of the status of the one or more radio network nodes 110, and ii) the one or more respective characteristics of the respective traffic between the one or more radio network nodes 110 and the second network node 102.

The another node 102, 110, 111 is also configured to initiate application of the compression and/or decompression of the determined respective type to the respective traffic in the respective link 141.

In some embodiments, the another node 102, 110, 111 may be further configured to send the respective first information from at least the first radio network node 111 of the one or more radio network nodes 110, to the first network node 101. The respective first indication configured to be obtained may be configured to be based on the respective first information configured to be sent.

In some embodiments, the respective first indication may be configured to be further based on the first predictive model of the respective traffic per radio network node of the one or more radio network nodes 110 configured to be determined.

In some embodiments, at least one of the following options may apply. According to a first option, the one or more respective indications of the status of the one or more radio network nodes 110 may be configured to be associated to the respective identifier of the one or more radio network nodes 110. According to a second option, the one or more respective indications of the status of the one or more radio network nodes 110 may be configured to comprise at least one of: i) the respective one or more indicators of the hardware status of the one or more radio network nodes 110 configured to comprise the one or more indicators of: computational, memory and power, ii) the respective current camping time of the respective set 131, 132, 133 of the one or more wireless devices 130 configured to be served by the respective one or more radio network nodes 110, iii) the respective first load of the one or more radio network nodes 110, and iv) the respective historical mobility propensity of the one or more radio network nodes 110. According to a third option, the one or more respective characteristics of the respective traffic may be configured to comprise the respective type of traffic. According to a fourth option, the one or more respective characteristics of the respective traffic may be configured to comprise the respective second information regarding the respective one or more wireless devices 130 configured to be respectively served by the one or more radio network nodes 110. According to a fifth option, the respective second information may be configured to comprise at least one of: a) the respective mobility information, b) the respective second capabilities of the one or more wireless devices 130, and c) the respective state of the respective radio link 160.

In some embodiments, initiating the application of the compression and/or decompression of the respective type configured to be determined may be configured to comprise at least one of: a) application of the compression and/or decompression of the respective type configured to be determined by the second network node 102 or at least the first radio network node 111 of the one or more radio network nodes 110, and b) sending at least the third indication configured to indicate the respective first indication configured to be obtained to the at least the first radio network node 111 of the one or more radio network nodes 110.

In some embodiments, the respective type of compression and/or decompression may be configured to be at least one of: a) based on the second load of the second network node 102, b) based on the respective first information configured to be obtained from the plurality or the totality of the radio network nodes 110, c) based on the one or more second respective indications of the second status of the second network node 102, wherein the one or more respective indications of the status of the one or more radio network nodes 110 may be configured to be the one or more respective first indications of the first status of the one or more radio network nodes 110, d) performed for the subset of the one or more radio network nodes 110 for the same or overlapping time period, e) determined using machine learning, f) determined using reinforcement learning by the one or more agents, and g) determined by the plurality of agents, each configured to determine the respective type of compression and/or decompression for the respective radio network node 110.

In some embodiments, at least one of may apply: a) the another network node 102, 110, 111 may be configured to be one of i) the first radio network node 111 of the one or more radio network nodes 110 and ii) the second network node 102, b) the respective traffic may be configured to comprise current traffic, c) the respective traffic may be configured to comprise current traffic and historical traffic, d) the first network node 101 may be configured to be the macro cell and each of the one or more radio network nodes 110 may be configured to be TRPs, e) the first network node 101 may be configured to be the same node as the second network node 102, f) the respective link 140 may be configured to be wireless, g) the respective wireless link 140 may be configured to be the respective fronthaul link, h) the second network node 102 may be configured to have the backhaul link 144 to the core network 120, and i) the communications network 100 may be configured to be the D-MIMO network.

In some embodiments, the respective first indication may be configured to further indicate the adaptation of the coding rate that may have to be used when applying the compression and/or decompression of the respective type.

The embodiments herein in the another node 102, 110, 111 may be implemented through one or more processors, such as a processing circuitry 601 in the another node 102, 110, 111 depicted in FIG. 6, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the another node 102, 110, 111. One such carrier may be in the form of a CD ROM disc. It is however feasible with other data carriers such as a memory stick. The computer program code may furthermore be provided as pure program code on a server and downloaded to the another node 102, 110, 111.

The another node 102, 110, 111 may further comprise a memory 602 comprising one or more memory units. The memory 602 is arranged to be used to store obtained information, store data, configurations, schedulings, and applications etc. to perform the methods herein when being executed in the another node 102, 110, 111.

In some embodiments, the another node 102, 110, 111 may receive information from, e.g., the first network node 101, the second network node 102, the core network 120, the one or more radio network nodes 110, e.g., the first radio network node 111, the one or more wireless devices 130, and/or another structure in the wireless communications network 100, through a receiving port 603. In some embodiments, the receiving port 603 may be, for example, connected to one or more antennas in another node 102, 110, 111. In other embodiments, the another node 102, 110, 111 may receive information from another structure in the wireless communications network 100 through the receiving port 603. Since the receiving port 603 may be in communication with the processing circuitry 601, the receiving port 603 may then send the received information to the processing circuitry 601. The receiving port 603 may also be configured to receive other information.

The processing circuitry 601 in the another node 102, 110, 111 may be further configured to transmit or send information to e.g., the first network node 101, the second network node 102, the core network 120, the one or more radio network nodes 110, e.g., the first radio network node 111, the one or more wireless devices 130, and/or another structure in the wireless communications network 100, through a sending port 604, which may be in communication with the processing circuitry 601, and the memory 602.

Those skilled in the art will also appreciate that the units comprised within the another node 102, 110, 111 described above as being configured to perform different actions, may refer to a combination of analog and digital circuits, and/or one or more processors configured with software and/or firmware, e.g., stored in memory, that, when executed by the one or more processors such as the processing circuitry 601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip.

Also, in some embodiments, the different units comprised within the another node 102, 110, 111 described above as being configured to perform different actions described above may be implemented as one or more applications running on one or more processors such as the processing circuitry 601.

Thus, the methods according to the embodiments described herein for the another node 102, 110, 111 may be respectively implemented by means of a computer program 605 product, comprising instructions, i.e., software code portions, which, when executed on at least one processing circuitry 601, cause the at least one processing circuitry 601 to carry out the actions described herein, as performed by the another node 102, 110, 111. The computer program 605 product may be stored on a computer-readable storage medium 606. The computer-readable storage medium 606, having stored thereon the computer program 605, may comprise instructions which, when executed on at least one processing circuitry 601, cause the at least one processing circuitry 601 to carry out the actions described herein, as performed by the another node 102, 110, 111. In some embodiments, the computer-readable storage medium 606 may be a non-transitory computer-readable storage medium, such as a CD ROM disc, or a memory stick. In other embodiments, the computer program 605 product may be stored on a carrier containing the computer program 605 just described, wherein the carrier is one of an electronic signal, optical signal, radio signal, or the computer-readable storage medium 606, as described above.

The another node 102, 110, 111 may comprise a communication interface configured to facilitate, or an interface unit to facilitate, communications between the another node 102, 110, 111 and other nodes or devices, e.g., the first network node 101, the second network node 102, the core network 120, the one or more radio network nodes 110, e.g., the first radio network node 111, the one or more wireless devices 130, and/or another structure in the wireless communications network 100. The interface may, for example, include a transceiver configured to transmit and receive radio signals over an air interface in accordance with a suitable standard.

In other embodiments, the another node 102, 110, 111 may comprise a radio circuitry 607, which may comprise e.g., the receiving port 603 and the sending port 604.

The radio circuitry 607 may be configured to set up and maintain at least a wireless connection with the first network node 101, the second network node 102, the core network 120, the one or more radio network nodes 110, e.g., the first radio network node 111, the one or more wireless devices 130, and/or another structure in the wireless communications network 100. Circuitry may be understood herein as a hardware component.

Hence, embodiments herein also relate to the another node 102, 110, 111 operative to operate in the wireless communications network 100. The another node 102, 110, 111 may comprise the processing circuitry 601 and the memory 602, said memory 602 containing instructions executable by said processing circuitry 601, whereby the another node 102, 110, 111 is further operative to perform the actions described herein in relation to the another node 102, 110, 111, e.g., in FIG. 3 and/or FIG. 4.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. S.-H. Park, O. Simeone, O. Sahin and S. Shamai Shitz, “FH Compression for Cloud Radio Access Networks: Signal processing advances inspired by network information theory,” in IEEE Signal Processing Magazine, vol. 31, no. 6, pp. 69-79, November 2014, doi: 10.1109/MSP.2014.2330031.
2. Masoumi et al., “Performance Analysis of Cell-Free Massive MIMO System with Limited FH Capacity and Hardware Impairments,”
3. I.-s. Kim et al., “Performance of Cell-Free MmWave Massive MIMO Systems with FH Compression and DAC Quantization,
4. Paikun Zhu et al., “Ultra-Low-Latency, High-Fidelity Analog-to-Digital-Compression Radio-Over-Fiber (ADX-RoF) for MIMO FH in 5G and Beyond,”
5. Paikun Zhu et al., “Adaptive space-time compression for efficient massive MIMO FHing,”
6. T. X. Vu, H. D. Nguyen and T. Q. S. Quek, “Adaptive Compression and Joint Detection for FH Uplinks in Cloud Radio Access Networks,” in IEEE Transactions on Communications, vol. 63, no. 11, pp. 4565-4575 November 2015, doi: 10.1109/TCOMM.2015.2475430.

1. A computer-implemented method performed by a first network node, the method being for handling compression of traffic, wherein first network node operates in a communications network, the method comprising:
obtaining respective first information from one or more radio network nodes, the one or more radio network nodes having access to a core network of the communications network via a respective link to a second network node operating in the communications network, the respective first information indicating:
i. one or more respective indications of a status of the one or more radio network nodes, and
ii. one or more respective characteristics of a respective traffic between the one or more radio network nodes and the second network node, and
determining, based on the obtained respective first information, a respective type of compression and/or decompression to be applied to the respective traffic in the respective link between at least a first radio network node of the one or more radio network nodes and the second network node, and
initiating application of the compression and/or decompression of the determined respective type to the respective traffic in the respective link.

2. The method according to claim 1, wherein the method further comprises:
determining, based on the obtained respective first information, a first predictive model of the respective traffic per radio network node of the one or more radio network nodes, and wherein the determining of the respective type of compression and/or decompression is further based on the determined first predictive model.

3. The method according to claim 2, wherein the determining of the first predictive model is performed using machine learning.

4. The method according to claim 1, wherein initiating the application of the compression and/or decompression of the determined respective type comprises at least one of:
application of the compression and/or decompression of the determined respective type by the second network node, and
sending a respective first indication to at least another network node, the another network node being one of: a) the first radio network node of the one or more radio network nodes and b) the second network node, the respective first indication indicating the determined type of compression and/or decompression.

5. The method according to claim 1, wherein at least one of:
the one or more respective indications of the status of the one or more radio network nodes are associated to a respective identifier of the one or more radio network nodes,
the one or more respective indications of the status of the one or more radio network nodes comprise at least one of:
i. respective one or more indicators of a hardware status of the one or more radio network nodes comprising one or more indicators of: computational, memory and power,
ii. a respective current camping time of a respective set of the one or more wireless devices served by the respective one or more radio network nodes,
iii. respective first load of the one or more radio network nodes, and
iv. respective historical mobility propensity of the one or more radio network nodes,
the respective traffic comprises current traffic,
the respective traffic comprises current traffic and historical traffic,
the one or more respective characteristics of the respective traffic comprise a respective type of traffic,
the one or more respective characteristics of the respective traffic comprise respective second information regarding respective one or more wireless devices respectively served by the one or more radio network nodes, and
the respective second information comprises at least one of: a) respective mobility information, b) respective second capabilities of the one or more wireless devices, and c) a respective state of the respective radio link.

6. (canceled)

7. The method according to claim 1, wherein at least one of:
the first network node manages a macro cell and each of the one or more radio network nodes are Transmission Points, TRPs,
the first network node is the same node as the second network node,
the respective link is wireless,
the respective wireless link is a respective fronthaul link,
the second network node has a backhaul link to the core network, and
the communications network is a distributed Multiple Input Multiple Output, D-MIMO, network.

8. The method according to claim 1, wherein the first network node further determines an adaptation of a coding rate that is to be used when applying the compression and/or decompression of the respective type, and wherein the determining of the respective type of compression and/or decompression to be applied to the respective traffic in the respective link is further based on the determined adaptation of the coding rate.

9. A computer-implemented method performed by another network node, the method being for handling compression of traffic, wherein the another network node operates in a communications network, the method comprising:
obtaining a respective first indication from a first network node operating in the communications network, the respective first indication indicating a respective type of compression and/or decompression to be applied to a respective traffic in a respective link between a respective radio network node of one or more radio network nodes and a second network node operating in the communications network, the one or more radio network nodes having access to a core network of the communications network via a respective link to the second network node, wherein the respective type of compression is based on respective first information, the respective first information indicating:
i. one or more respective indications of a status of the one or more radio network nodes, and
ii. one or more respective characteristics of a respective traffic between the one or more radio network nodes and the second network node, and
initiating application of the compression and/or decompression of the determined respective type to the respective traffic in the respective link.

10. The method according to claim 9, further comprising:
sending the respective first information from at least a first radio network node of the one or more radio network nodes, to the first network node, and wherein the obtained respective first indication is based on the sent respective first information.

11. The method according to claim 9, wherein the respective first indication is further based on a determined first predictive model of the respective traffic per radio network node of the one or more radio network nodes.

12. The method according to claim 9, wherein at least one of:
the one or more respective indications of the status of the one or more radio network nodes are associated to a respective identifier of the one or more radio network nodes,
the one or more respective indications of the status of the one or more radio network nodes comprise at least one of:
i. respective one or more indicators of a hardware status of the one or more radio network nodes comprising one or more of indicators: computational, memory and power,
ii. a respective current camping time of a respective set of the one or more wireless devices served by the respective one or more radio network nodes,
iii. respective first load of the one or more radio network nodes, and
iv. respective historical mobility propensity of the one or more radio network nodes,
the one or more respective characteristics of the respective traffic comprise a respective type of traffic,
the one or more respective characteristics of the respective traffic comprise respective second information regarding respective one or more wireless devices respectively served by the one or more radio network nodes, and
the respective second information comprises at least one of: a) respective mobility information, b) respective second capabilities of the one or more wireless devices, and c) a respective state of the respective radio link.

13. The method according to claim 9, wherein initiating the application of the compression and/or decompression of the determined respective type comprises one of:
application of the compression and/or decompression of the determined respective type by the second network node or at least a first radio network node of the one or more radio network nodes, and
sending at least a third indication indicating the obtained respective first indication to the at least a first radio network node of the one or more radio network nodes.

14. The method according to claim 9, wherein the respective type of compression and/or decompression is at least one of:
based on a second load of the second network node,
based on respective first information obtained from a plurality or the totality of the radio network nodes,
based on one or more second respective indications of a second status of the second network node, wherein the one or more respective indications of the status of the one or more radio network nodes are one or more respective first indications of a first status of the one or more radio network nodes,
performed for a subset of the one or more radio network nodes for a same or overlapping time period,
determined using machine learning,
determined using reinforcement learning by one or more agents, and
determined by a plurality of agents, each performing the determining of the respective type of compression and/or decompression for a respective radio network node.

15. (canceled)

16. The method according to claim 9, wherein the respective first indication further indicates an adaptation of a coding rate that is to be used when applying the compression and/or decompression of the respective type.

17. A first network node, for handling compression of traffic, the first network node being configured to operate in a communications network, the first network node being further configured to:
obtain respective first information from one or more radio network nodes, the one or more radio network nodes being configured to have access to a core network of the communications network via a respective link to a second network node configured to operate in the communications network, the respective first information being configured to indicate:
i. one or more respective indications of a status of the one or more radio network nodes, and
ii. one or more respective characteristics of a respective traffic between the one or more radio network nodes and the second network node, and
determine, based on the respective first information configured to be obtained, a respective type of compression and/or decompression to be applied to the respective traffic in the respective link between at least a first radio network node of the one or more radio network nodes and the second network node, and
initiate application of the compression and/or decompression of the respective type configured to be determined, to the respective traffic in the respective link.

18. The first network node according to claim 17, wherein the first network node is further configured to:
determine, based on the respective first information configured to be obtained, a first predictive model of the respective traffic per radio network node of the one or more radio network nodes, and wherein the determining of the respective type of compression and/or decompression is configured to be further based on the first predictive model configured to be determined.

19. The first network node according to claim 18, wherein the determining of the first predictive model is configured to be performed using machine learning.

20-24. (canceled)

25. A another network node, for handling compression of traffic, the another network node being configured to operate in a communications network, the another network node being further configured to:
obtain a respective first indication from a first network node configured to operate in the communications network, the respective first indication being configured to indicate a respective type of compression and/or decompression to be applied to a respective traffic in a respective link between a respective radio network node of one or more radio network nodes and a second network node configured to operate in the communications network, the one or more radio network nodes being further configured to have access to a core network of the communications network via a respective link to the second network node, wherein the respective type of compression is configured to be based on respective first information, the respective first information being configured to indicate:
i. one or more respective indications of a status of the one or more radio network nodes, and
ii. one or more respective characteristics of a respective traffic between the one or more radio network nodes and the second network node, and
initiate application of the compression and/or decompression of the determined respective type to the respective traffic in the respective link.

26. The another network node according to claim 25, being further configured to:
send the respective first information from at least a first radio network node of the one or more radio network nodes, to the first network node, and wherein the respective first indication configured to be obtained is configured to be based on the respective first information configured to be sent.

27. The another network node according to claim 25, wherein the respective first indication is configured to be further based on a first predictive model of the respective traffic per radio network node of the one or more radio network nodes configured to be determined.

28-36. (canceled)
